(19) United States
(12) Patent Application Publication
(10) Pub. No.: US 2024/0373436 A1
(43) Pub. Date: Nov. 7, 2024

(54) TRANSMISSION SETTING INDICATION FOR SWITCHING OPERATION ZONES

(71) Applicant: Samsung Electronics Co., Ltd., Suwon-si (KR)

(72) Inventors: Young Han Nam, Plano, TX (US); Jianhua Mo, Allen, TX (US)

(21) Appl. No.: 18/651,532

(22) Filed: Apr. 30, 2024

Related U.S. Application Data
(60) Provisional application No. 63/464,441, filed on May 5, 2023.
(60) Provisional application No. 63/525,556, filed on Jul. 7, 2023.

(51) Int. Cl. H04W 72/23; H04B 7/06; H04L 5/00

(52) U.S. Cl. CPC H04W 72/23; H04B 7/0617; H04B 7/0697; H04L 5/0094

(57) ABSTRACT

Methods and apparatuses for a transmission setting indication for switching operation zones in wireless communication systems are provided. The methods of UE comprise: receiving configuration information including (i) a first configuration corresponding to a first transmission/reception setting and (ii) a second configuration corresponding to a second transmission/reception setting, wherein the configuration information is included in an RRC message; receiving an indication indicating whether to switch an operating configuration, the being included in a MAC CE or DCI; determining whether the operating configuration is the first configuration or the second configuration; determining, based on the indication, whether to switch the operating configuration between the first configuration and the second configuration; and switching, based on a determination, the operating configuration from the first configuration to the second configuration, wherein the first and second transmission/reception setting associated with a number of transmission layers for a spatial multiplexing operation or a beamforming operation.

### CROSS-REFERENCE TO RELATED APPLICATIONS AND CLAIM OF PRIORITY

The present application claims priority to U.S. Provisional Patent Application No. 63/464,441, filed on May 5, 2023, and U.S. Provisional Patent Application No. 63/525,556, filed on Jul. 7, 2023. The contents of the above-identified patent documents are incorporated herein by reference.

### TECHNICAL FIELD

The present disclosure relates generally to wireless communication systems and, more specifically, the present disclosure relates to a transmission setting indication for switching operation zones in wireless communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a transmission setting indication for switching operation zones in wireless communication systems.

In one embodiment, A user equipment (UE) in a wireless communication system is provided. The UE comprise a transceiver configured to: receive, from a base station (BS), configuration information including (i) a first configuration corresponding to a first transmission/reception setting and (ii) a second configuration corresponding to a second transmission/reception setting, wherein the configuration information is included in a radio resource control (RRC) message, and receive, from the BS, an indication indicating whether to switch an operating configuration, wherein the indication is included in a medium access control control element (MAC CE) or downlink control information (DCI). The UE further comprises a processor operably coupled to the transceiver, the processor configured to: determine whether the operating configuration is the first configuration or the second configuration, determine, based on the indication, whether to switch the operating configuration between the first configuration and the second configuration, and switch, based on a determination that the operating configuration is indicated to be switched and the operating configuration is the first configuration, the operating configuration from the first configuration to the second configuration, wherein the first transmission/reception setting and the second transmission/reception setting are associated with a number of transmission layers for a spatial multiplexing operation or a beamforming operation.

In another embodiment, a method of a UE is provided. The method comprises: receiving, from a BS, configuration information including (i) a first configuration corresponding to a first transmission/reception setting and (ii) a second configuration corresponding to a second transmission/reception setting, wherein the configuration information is included in an RRC message; receiving, from the BS, an indication indicating whether to switch an operating configuration, wherein the indication is included in a MAC CE or DCI; determining whether the operating configuration is the first configuration or the second configuration; determining, based on the indication, whether to switch the operating configuration between the first configuration and the second configuration; and switching, based on a determination that the operating configuration is indicated to be switched and the operating configuration is the first configuration, the operating configuration from the first configuration to the second configuration, wherein the first transmission/reception setting and the second transmission/reception setting are associated with a number of transmission layers for a spatial multiplexing operation or a beamforming operation.

In yet another embodiment, a BS in a wireless communication system is provided. The BS comprises a processor configured to: generate configuration information including (i) a first configuration corresponding to a first transmission/reception setting and (ii) a second configuration corresponding to a second transmission/reception setting, and generate an indication indicating whether to switch an operating configuration. The BS further comprises a transceiver operably coupled to the processor, the transceiver configured to: transmit, to a UE via an RRC message, the configuration information, and transmit, to the UE via a MAC CE or DCI, the indication, wherein: the operating configuration is the first configuration or the second configuration,; the switch of the operating configuration between the first configuration and the second configuration is based on the indication,, and the first transmission/reception setting and the second transmission/reception setting are associated with a number of transmission layers for a spatial multiplexing operation or a beamforming operation.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate example of wireless transmit and receive paths according to various embodiments of the present disclosure;

FIG. 6 illustrates an example of antenna structure according to various embodiments of the present disclosure;

FIG. 7 illustrates an example of RRC configuration parameter tree according to various embodiments of the present disclosure;

FIG. 8 illustrates an example of RRC parameters under BWP-DownlinkDedicated according to various embodiments of the present disclosure;

FIG. 9 illustrates an example of Zone 1 and Zone 2 according to various embodiments of the present disclosure;

FIG. 10 illustrates an example of 8 beams used to cover an angular coverage of a cell according to various embodiments of the present disclosure;

FIG. 11 illustrates an examples of a UE group partitioning according to various embodiments of the present disclosure;

FIG. 12 illustrates an examples of UE's zone switching according to various embodiments of the present disclosure;

FIG. 13 illustrates another examples of UE's zone switching according to various embodiments of the present disclosure;

FIG. 14 illustrates a flowchart of a BS method for TRx setting switching according to various embodiments of the present disclosure;

FIG. 15 illustrates a flowchart of a UE method for TRx setting switching according to various embodiments of the present disclosure;

FIG. 16 illustrates a flowchart of a zone/beam switch and indication according to various embodiments of the present disclosure;

FIG. 17 illustrates an examples of UE's zone switching according to various embodiments of the present disclosure;

FIG. 18 illustrates another examples of UE's zone switching according to various embodiments of the present disclosure;

FIG. 19 illustrates an examples of zone ID that is implicated indicated through TCI according to various embodiments of the present disclosure;

FIG. 20 illustrates an examples of zone-specific beam management according to various embodiments of the present disclosure; and

FIG. 21 illustrates a flowchart of UE method for a transmission setting indication for switching operation zones according to various embodiments of the present disclosure.

### DETAILED DESCRIPTION

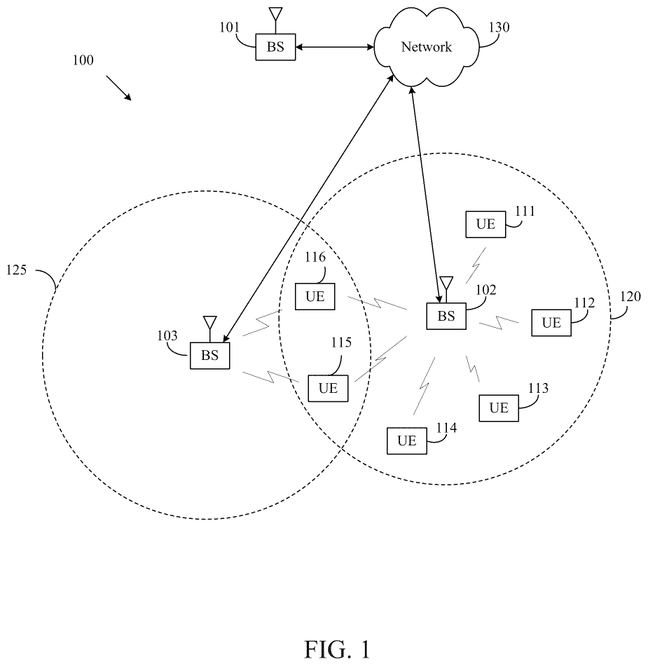

FIG. 1 through FIG. 21, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to various embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to receive and/or identify a transmission setting indication for switching operation zones in wireless communication systems. In certain embodiments, and one or more of the gNBs 101-103 includes circuitry, programing, or a combination thereof, to support a transmission setting indication for switching operation zones in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

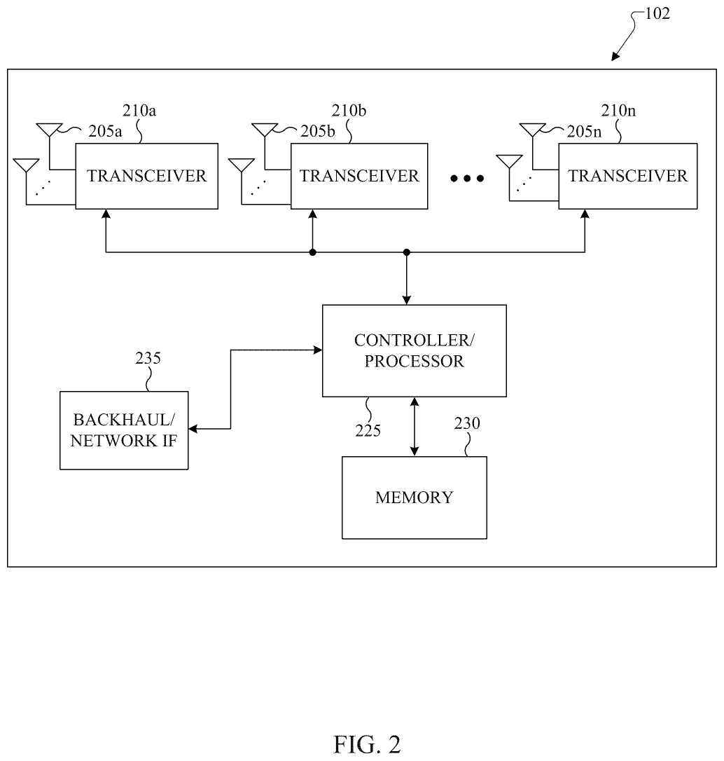

FIG. 2 illustrates an example gNB 102 according to various embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support a transmission setting indication for switching operation zones in wireless communication systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a wireless communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

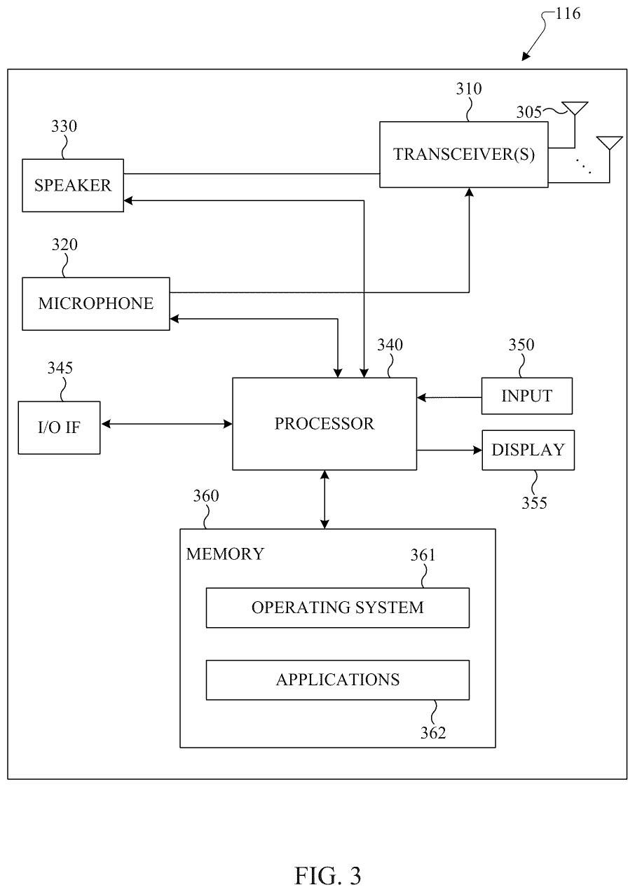

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes to support a transmission setting indication for switching operation zones in wireless communication systems.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

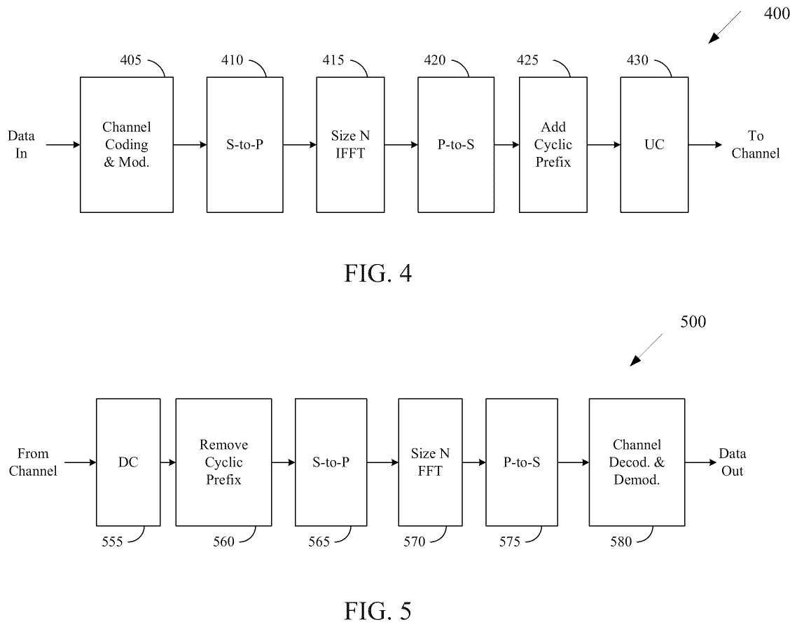

FIG. 4 and FIG. 5 illustrate example wireless transmit and receive paths according to various embodiments of the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support a transmission setting indication for switching operation zones in wireless communication systems.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. A UE can determine CSI-RS transmission parameters through DL control signaling or higher layer signaling, such as a radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

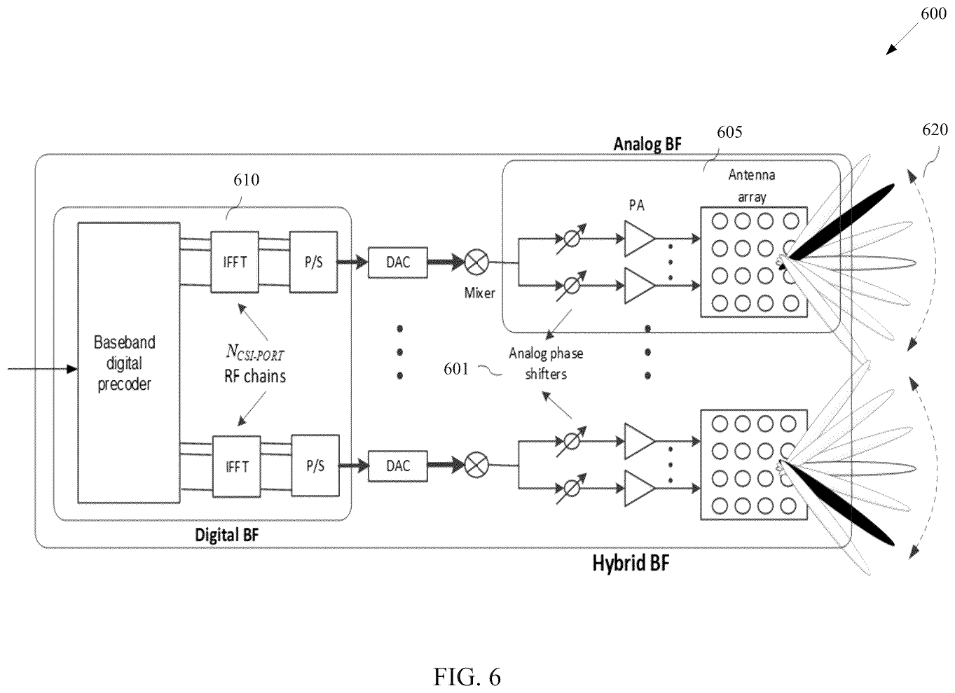

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies) as illustrated in FIG. 6.

FIG. 6 illustrates an example antenna structure 600 according to various embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports NCSI-PORT. A digital beamforming unit 610 performs a linear combination across NCSI-PORT analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @ 100 m distance), larger number of and sharper analog beams (hence larger number of radiators in the array) may be needed to compensate for the additional path loss.

The IE TCI-State associates one or two DL reference signals with a corresponding quasi-colocation (QCL) type. TABLE 1 shows TCI-State information element

TABLE 1
TCI-State information element

```
-- ASN1START
-- TAG-TCI-STATE-START
TCI-State ::= SEQUENCE {
  tci-StateId TCI-StateId,
  qcl-Type1 QCL-Info,
  qcl-Type2 QCL-Info OPTIONAL, -- Need R
  ...,
  [[
  additionalPCI-r17 AdditionalPCIIndex-r17 OPTIONAL, -- Need R
  pathlossReferenceRS-Id-r17 PUSCH-PathlossReferenceRS-Id
  OPTIONAL, -- Cond
  JointTCI
  ul-powerControl-r17 Uplink-powerControlId-r17 OPTIONAL -- Cond
  JointTCI
  ]]
}
QCL-Info ::= SEQUENCE {
  cell ServCellIndex OPTIONAL, -- Need R
  bwp-Id BWP-Id OPTIONAL, -- Cond CSI-RS-Indicated
  referenceSignal CHOICE {
  csi-rs NZP-CSI-RS-ResourceId,
  ssb SSB-Index
  },
  qcl-Type ENUMERATED {typeA, typeB, typeC, typeD},
  ...
}
```

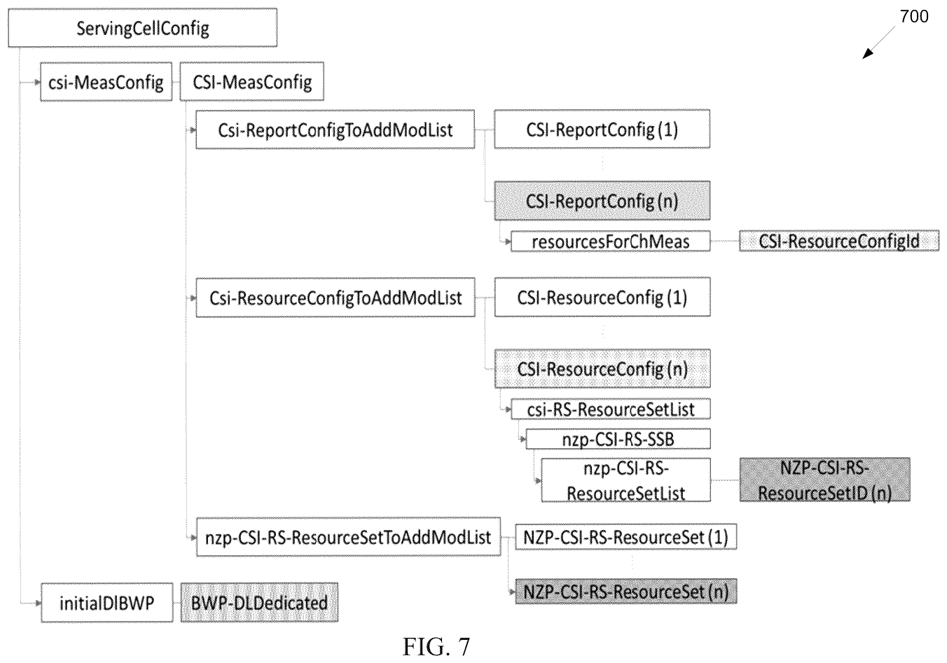

FIG. 7 illustrates an example of RRC configuration parameter tree 700 according to various embodiments of the present disclosure. An embodiment of the RRC configuration parameter tree 700 shown in FIG. 7 is for illustration only.

FIG. 7 illustrates RRC configuration parameter tree, starting from ServingCellConfig. ServingCellConfig's children include csi-MeasConfig and initialDIBWP (i.e., initialDownlinkBWP).

A CSI measurement config, Csi-MeasConfig, is configured per serving cell, and encloses a list of report config, a list of resource config and a list of CSI-RS resource set config. Children of Csi-MeasConfig includes Csi-ReportConfigToAddModList, Csi-ResourceConfigToAddModList and nzp-CSI-RS-ResourceSetToAddModList, which respectively informs a list of CSI report configurations, a list of CSI resource configurations, and a list of NZP CSI-RS resource sets to a UE. An NZP-CSI-RS resourceSet configured through nzp-CSI-RS-ResourceSetToAddModList has a unique CSI-RS resource ID, which is used to indicate a CSI-RS resource set that comprises a CSI-ResourceConfig. The ID of an CSI-ResourceConfig is used to indicate a CSI resource that may be used for a specific measurement report, configured via a CSI-ReportConfig.

Some other configurations, e.g., TCI (transmit configuration indicator) is configured per bandwidth part. In the tree in FIG. 7, ServingCellConfig has a child initialDownlinkBWP, whose parameters are specified according to BWP-DownlinkDedicated.

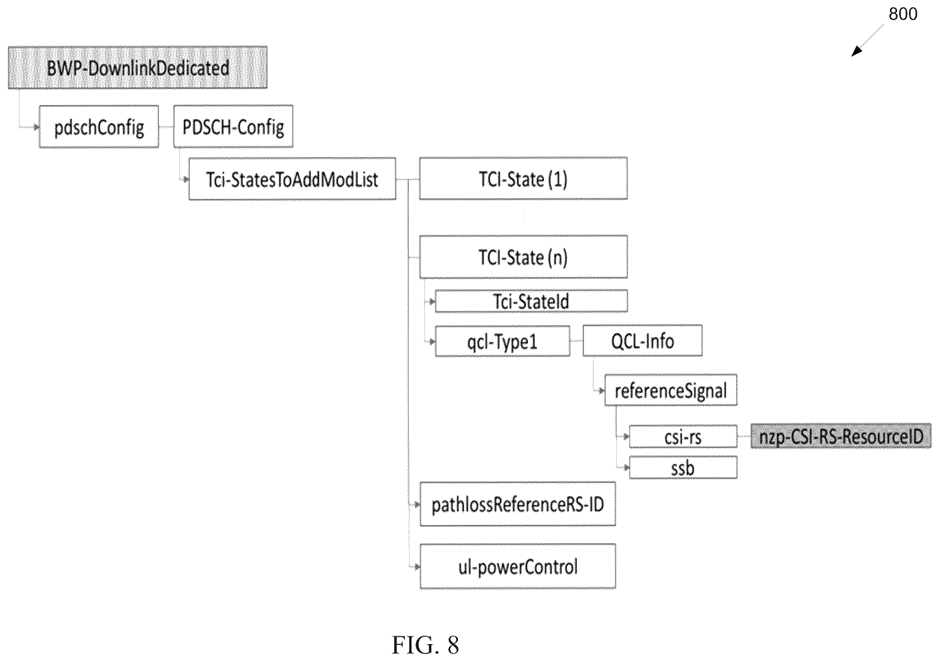

FIG. 8 illustrates an example of RRC parameters under BWP-DownlinkDedicated 800 according to various embodiments of the present disclosure. An embodiment of the RRC parameters under BWP-DownlinkDedicated 800 shown in FIG. 8 is for illustration only.

FIG. 8 illustrates a tree of RRC parameters under BWP-DownlinkDedicated. BWP-DownlinkDedicated has a child named pdschConfig, which has a child named Tci-StatesToAddModList, which comprises a list of TCIStates. For each TCI state, the network configures a reference signal (RS) that is QCL associated with the TCI, and also uplink beam power control and beam management related information, e.g., pathlossReferenceRS and ulPowerControl.

The IE BWP-DownlinkDedicated is used to configure the dedicated (UE specific) parameters of a downlink BWP.

TABLE 2 shows BWP-DownlinkDedicated information element.

TABLE 2
BWP-DownlinkDedicated information element

BWP-DownlinkDedicated ::= SEQUENCE {
pdcch-Config SetupRelease { PDCCH-Config } OPTIONAL, -- Need M
pdsch-Config SetupRelease { PDSCH-Config } OPTIONAL, -- Need M
sps-Config SetupRelease { SPS-Config } OPTIONAL, -- Need M
radioLinkMonitoringConfig SetupRelease { RadioLinkMonitoringConfig } OPTIONAL, --
Need M
...,
[[
sps-ConfigToAddModList-r16 OPTIONAL, -- Need N
sps-ConfigToReleaseList-r16 SPS-ConfigToReleaseList-r16 OPTIONAL, -- Need N
sps-ConfigDeactivationStateList-r16 SPS-ConfigDeactivationStateList-r16 OPTIONAL, --
Need R
beamFailureRecoverySCellConfig-r16 SetupRelease {BeamFailureRecoveryRSConfig-r16}
OPTIONAL, -- Cond SCellOnly
sl-PDCCH-Config-r16 SetupRelease { PDCCH-Config } OPTIONAL, -- Need M
sl-V2X-PDCCH-Config-r16 SetupRelease { PDCCH-Config } OPTIONAL -- Need M
]],
[[
preConfGapStatus-r17 BIT STRING (SIZE (maxNrofGapId-r17)) OPTIONAL, -- Cond
PreConfigMG
beamFailureRecoverySpCellConfig-r17 SetupRelease { BeamFailureRecoveryRSConfig-r16}
OPTIONAL, -- Cond SpCellOnly
harq-FeedbackEnablingforSPSactive-r17 BOOLEAN OPTIONAL, -- Need R
cfr-ConfigMulticast-r17 SetupRelease { CFR-ConfigMulticast-r17 } OPTIONAL, -- Need M
dl-PPW-PreConfigToAddModList-r17 DL-PPW-PreConfigToAddModList-r17 OPTIONAL, -
- Need N
dl-PPW-PreConfigToReleaseList-r17 DL-PPW-PreConfigToReleaseList-r17 OPTIONAL, --
Need N
nonCellDefiningSSB-r17 NonCellDefiningSSB-r17 OPTIONAL, -- Need R
servingCellMO-r17 MeasObjectId OPTIONAL -- Cond MeasObject-NCDSSB
]]
}

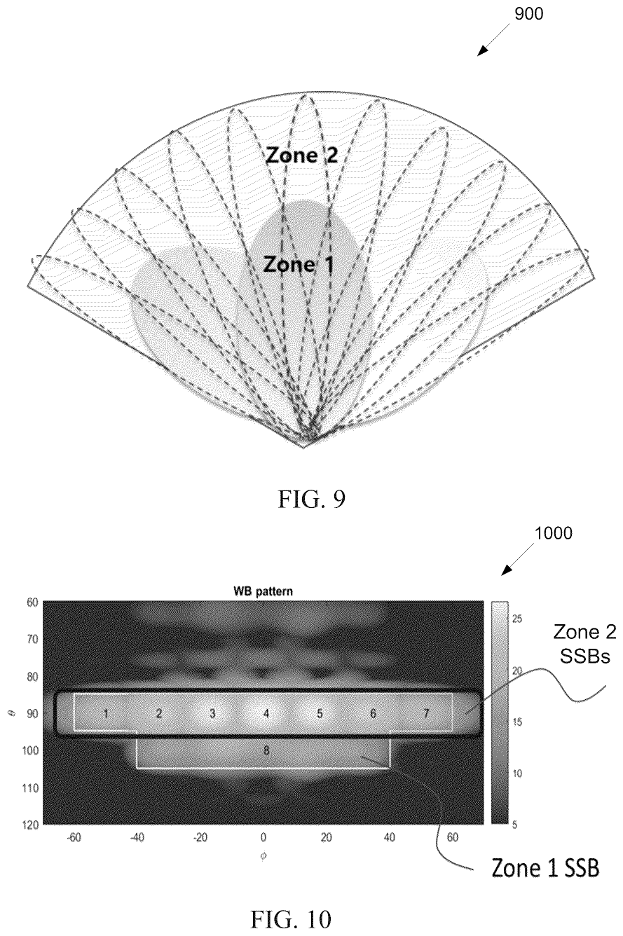

FIG. 9 illustrates an example of Zone 1 and Zone 2 900 according to various embodiments of the present disclosure. An embodiment of the Zone 1 and Zone 2 900 shown in FIG. 9 is for illustration only.

FIG. 9 illustrates a partition of a cell into two zones. Each zone comprises a number of beams covering different geographical area.

FIG. 10 illustrates an example of 8 beams used to cover an angular coverage of a cell 1000 according to various embodiments of the present disclosure. An embodiment of the 8 beams used to cover an angular coverage of a cell 1000 shown in FIG. 10 is for illustration only.

FIG. 10 illustrates 8 beams used to cover an angular coverage (azimuth ϕ, and zenith θ) of a cell. In some embodiments, those beams that are pointing towards higher zenith angle (i.e., the zenith beam center is >90 deg) are used for zone 1, and those beams that are pointing towards a zenith angle close to 90 deg are used for zone 2, because ˜90 deg zenith angle means cell edge, and >90 deg zenith angle means cell center in some embodiments. As such, zone 1 comprises beam 8, and zone 2 comprises beams 1 through 7 in FIG. 10 in these embodiments.

In some embodiments, these beams comprising a zone are used for transmitting SSBs (synchronization signal and PBCH blocks).

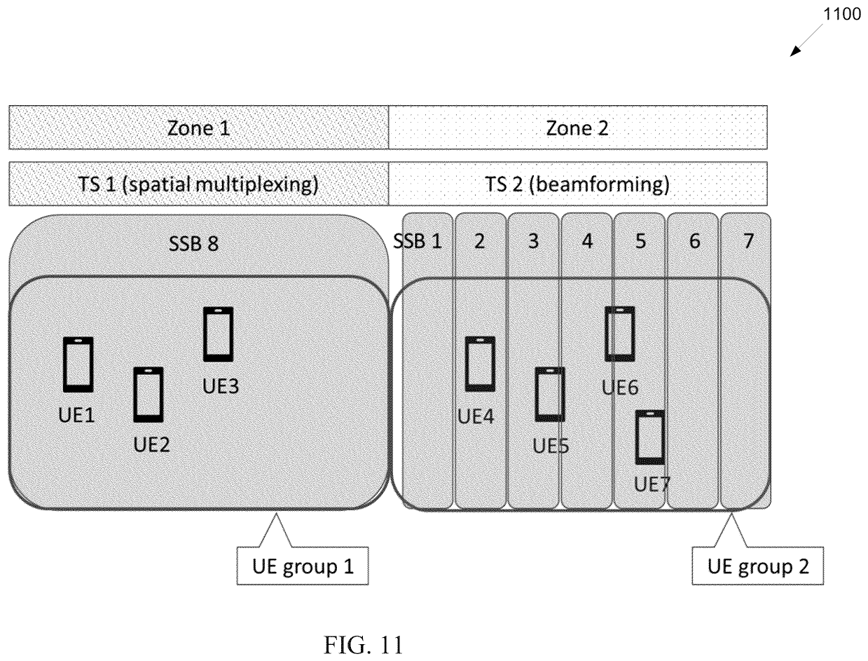

FIG. 11 illustrates an examples of a UE group partitioning 1100 according to various embodiments of the present disclosure. An embodiment of the UE group partitioning 1100 shown in FIG. 11 is for illustration only.

FIG. 11 illustrates a UE group partitioning according to the spatial zones according to some embodiments of the present disclosure. The BS partitions SSBs into two groups and associates a group with a zone. Furthermore, the BS partitions users into two groups, based on the individual users' serving SSBs. A UE is configured with a serving SSB by a BS, which is indicated via a TCI. The BS determines a serving SSB for a UE considering the SSB RSRP reports from the UE. For example, the BS may choose a serving RSRP, which achieves the best RSRP among all the SSBs the BS has transmitted.

In some embodiments, the BS applies different transmission settings for different user groups and operates different schedulers for the different user groups. In one example, the BS applies spatial multiplexing for a first group of users associated with zone 1 SSB, and beamforming for a second group of users associated with zone 2 SSB. Here TS means transmission setting.

In one example of TS 1, a high-order spatial multiplexing for cell center users is provided: (1) coverage by wide beams (TDM (FDM also possible)) and (2) high SU/MU-MIMO capacity.

In one example of TS 2, a beamforming for cell edge users is provided: (1) coverage by narrow beamforming (TDM+FDM); (2) SU-MIMO for coverage; and (3) FDM of cell edge UEs within each analog beam.

In some embodiments, when a UE moves around the area, the BS updates a transmission setting for the UE, from zone 1 to zone 2 or zone 2 to zone 1. As such, the BS gives an indication for a UE to switch a zone. The zone switch signaling can be designed in either implicit or explicit manner. In case of explicit indication, the standards spec supports an explicit “zone” switching signaling, which is coupled with various other parameter configurations. In case of implicit indication, the standards spec does not include explicit zone concept, but the standards define various parameters related to define the zone and lets the BS to switch a group of parameters together for a UE, to facilitate the UE's zone switching.

3GPP NR has introduced various MAC CE commands to specifically treat dynamic switching of parameters. In 3GPP standard specification 38.321, the following description are provided: (1) SP CSI-RS/CSI-IM Resource set activation/deactivation MAC CE; (2) aperiodic CSI trigger state subselection MAC CE; (3) TCI States activation/deactivation for UE-specific PDSCH MAC CE; (4) TCI State Indication for UE-specific PDCCH MAC CE; (5) SP CSI reporting on PUCCH activation/deactivation MAC CE; (6) SP SRS activation/deactivation MAC CE; (7) PUCCH spatial relation activation/deactivation MAC CE; (8) enhanced PUCCH spatial relation activation/deactivation MAC CE; (9) SP ZP CSI-RS resource set Activation/Deactivation MAC CE; (10) recommended Bit Rate MAC CE; (11) enhanced SP/AP SRS spatial relation indication MAC CE; (12) SRS pathloss reference RS update MAC CE; (13) PUSCH pathloss reference RS update MAC CE; (14) serving cell set based SRS spatial relation indication MAC CE; (15) SP positioning SRS activation/deactivation MAC CE; (16) timing delta MAC CE; (17) guard symbols MAC CEs; (18) positioning measurement Gap activation/deactivation command MAC CE; (19) PPW activation/deactivation command MAC CE; (20) PUCCH spatial relation activation/deactivation for multiple TRP PUCCH repetition MAC CE; (21) PUCCH power control set Update for multiple TRP PUCCH repetition MAC CE; (22) unified TCI states activation/deactivation for UE-specific PDSCH MAC CE; and/or (23) differential Koffset MAC CE.

Individual signaling of these different MAC CEs for the zone switching incur non-necessary signaling overhead. The present disclosure provides the MAC CE signaling overhead issue, by grouping parameters that may be activated/de-activated/updated by a single MAC CE command. For the zone switching, multiple parameters may tend to be switched together, and these parameters can be grouped; and these set of parameters are activated/de-activated/updated by a single MAC-CE command.

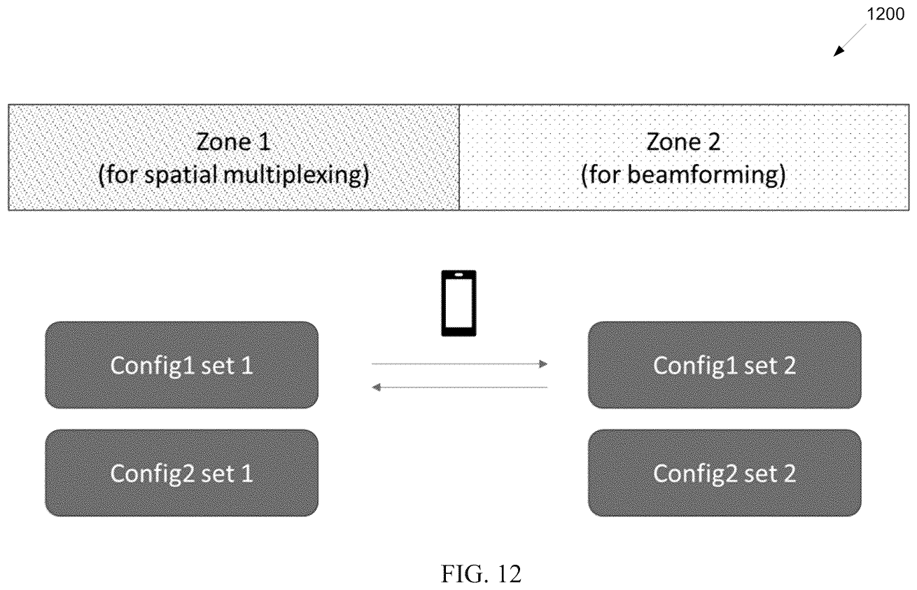

FIG. 12 illustrates an examples of UE's zone switching 1200 according to various embodiments of the present disclosure. An embodiment of the UE's zone switching 1200 shown in FIG. 12 is for illustration only.

FIG. 12 illustrates an idea that a UE's zone switching is facilitated by a number of MAC CE commands, i.e., the UE is configured to switch between two pre-configured RRC parameter sets by a MAC CE commands.

In some embodiments, each SSB and each CSI-RS resource is associated with a zone, and SSB/CSI-RS to zone association is explicitly indicated to a UE. Upon receiving a zone information, the UE determines a transmission/reception (TRx) operation mode, and tune its RF and/or baseband accordingly. As such, zone index may be called as TRx setting indicator (TSI) instead.

In some embodiments, the most significant bit (MSB) or least significant bit (LSB) of an SSB ID indicates a TSI ID. For example, MSB state of “0” means TSI0, and MSB state of “1” means TSI1; or vice versa.

In some embodiments, the CSI-RS resource configuration includes a bit field indicating a TSI.

In some embodiments, a BS decides the zone switch of users based on the RSRP reports of zone 1 and zone 2 reference signals and/or the traffic load of the zone 1 and zone 2 users.

In one embodiment, the transmission configuration indicator (TCI) is used for the zone ID (or TSI) indication from BS to UE.

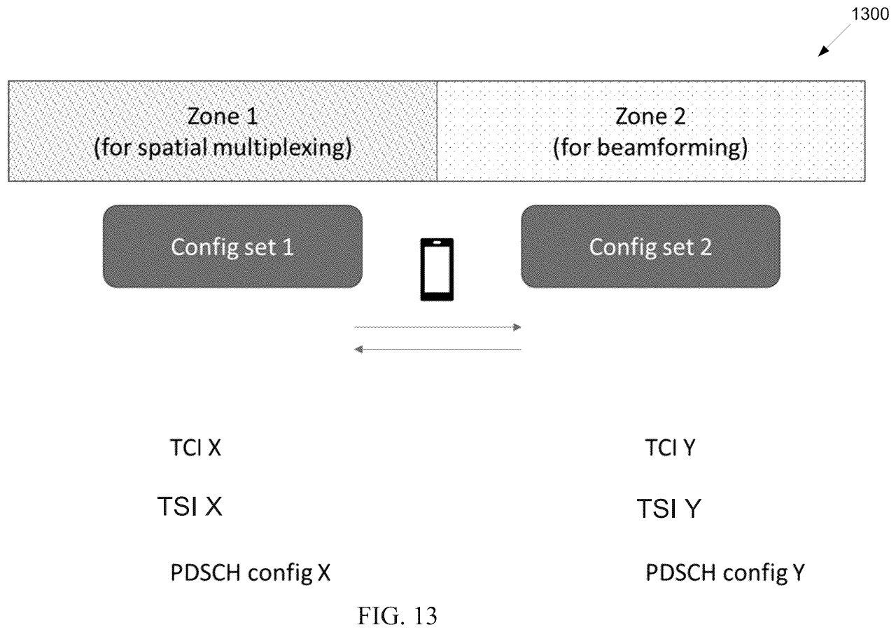

FIG. 13 illustrates another examples of UE's zone switching 1300 according to various embodiments of the present disclosure. An embodiment of the UE's zone switching 1300 shown in FIG. 13 is for illustration only.

A BS uses a MAC-CE or a DCI signaling to switch multiple parameters that are required to be signaled to the UE for the zone or transmission setting switching.

These parameters are grouped into an RRC information element (this may be denoted as a mode config set, or a config set), which include at least one of maximum rank, a UE Rx beamforming, beam reporting configurations, beam correspondence operations, SRS resource set ID, CSI report configuration ID, etc.

A UE is configured with a number of such information element and is firstly configured a default information element. Subsequently, when UE moves to a coverage area where the UE's TRx setting may change, the UE gets a MAC-CE command or a DCI command to use another information elements among those initially configured information elements.

For this purpose, the BS configures multiple sets of these parameter values (i.e., the number of such information elements) through RRC signaling, and the BS later transmits MAC-CE or DCI to switch form one set to another set. The BS achieves a UE zone switching, by means of parameter set switching. This is illustrated in FIG. 13.

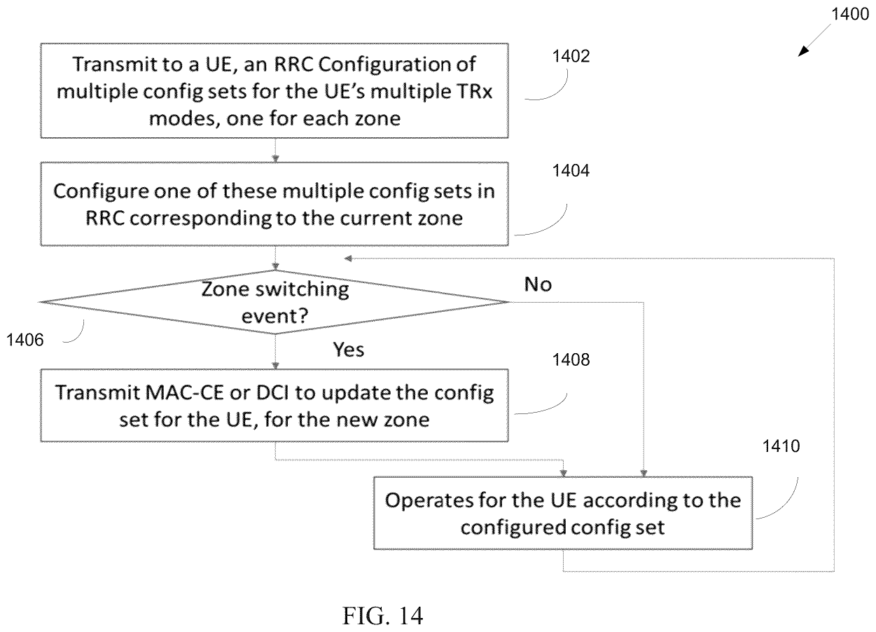

FIG. 14 illustrates a flowchart of a BS method for TRx setting switching 1400 according to various embodiments of the present disclosure. An embodiment of the BS method for TRx setting switching 1400 shown in FIG. 14 is for illustration only. The BS method for TRx setting switching 1400 as may be performed by a BS (e.g., 101-103 as illustrated in FIG. 1). An embodiment of the BS method for TRx setting switching 1400 shown in FIG. 14 is for illustration only. One or more of the components illustrated in FIG. 14 can be implemented in specialized circuitry configured to perform the noted functions or one or more of the components can be implemented by one or more processors executing instructions to perform the noted functions.

FIG. 14 illustrates BS implementation of zone switching, according to some embodiments of the present disclosure. A BS first configures multiple config sets for a UE via an RRC signaling, one config set per zone or a UE TRx setting. The BS further configures one of these multiple config sets for a UE to use. When the BS finds a zone switching event occurred for the UE, the BS transmits MAC-CE or DCI to update the UE with another config set among the RRC configured config sets, corresponding for the new zone. The BS operates the BS TRx for the UE according to the configured config set.

As illustrated in FIG. 14, in step 1402, the BS transmits, to a UE, an RRC configuration of multiple configuration sets for the UE's multiple TRx setting. In step 1404, the BS configures one of the multiple configuration sets in the RRC corresponding to the current zone. In step 1406, the BS determines whether zone switching event occurs. In step 1406, if the event occurs, the BS in step 1408, transmits MAC-CE or DCI to update the configuration set for the UE for the new zone. In step 1406, if the even does not occur, the BS in step 1410 operates for the UE according to the configured configuration set.

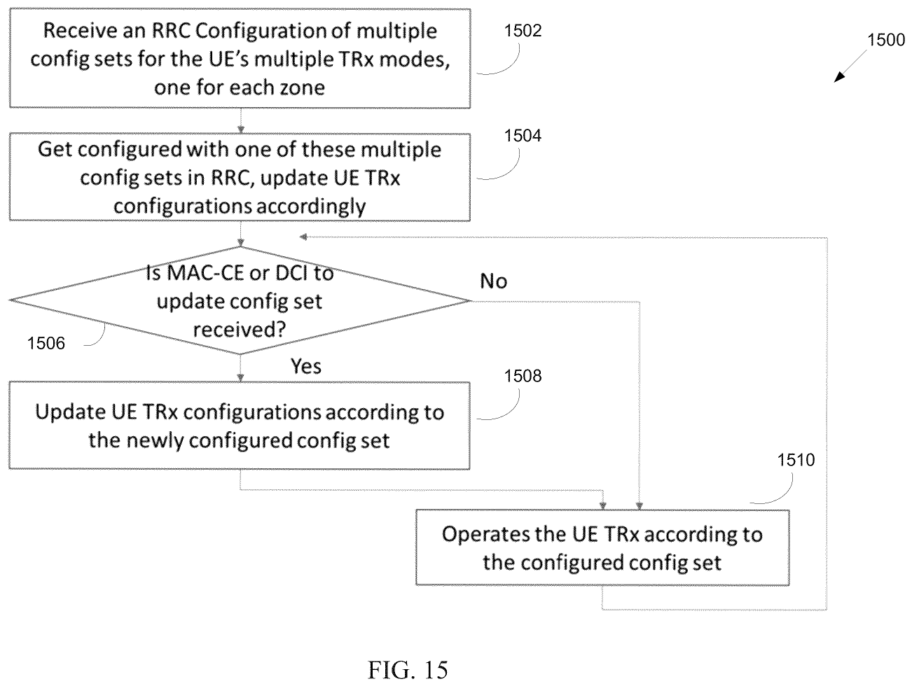

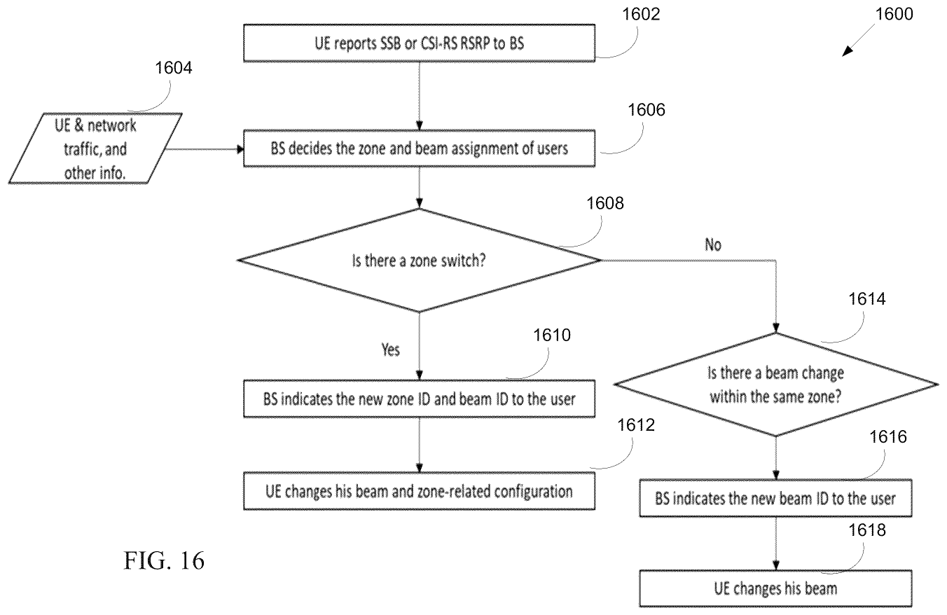

FIG. 15 illustrates a flowchart of a UE method for TRx setting switching 1500 according to various embodiments of the present disclosure. An embodiment of the UE method for TRx setting switching 1500 shown in FIG. 15 is for illustration only. The UE method for TRx setting switching 1500 as may be performed by a UE (e.g., 111-116 as illustrated in FIG. 1). An embodiment of the UE method for TRx setting switching 1500 shown in FIG. 15 is for illustration only. One or more of the components illustrated in FIG. 15 can be implemented in specialized circuitry configured to perform the noted functions or one or more of the components can be implemented by one or more processors executing instructions to perform the noted functions.

FIG. 15 illustrates a UE implementation of TRx setting switching, according to some embodiments of the present disclosure. The UE first receives multiple config sets from the BS via an RRC signaling, one config set per UE TRx setting. The UE is further configured with one of these multiple config sets. When the UE receives MAC-CE or DCI to update to another config set among the RRC configured config sets, the UE updates the UE TRx configurations according to the new config set. The UE operates the UE TRx according to the configured config set.

As illustrate in FIG. 15, in step 1502, the UE receive, from a BS, an RRC configuration of multiple configuration sets for the UE's multiple TRx setting, for example one for each zone. In step 1504, the UE is configured with one of the multiple configuration sets in the RRC, update UE TRx configuration accordingly. In step 1506, the UE determines whether the MAC-CE or DCI is received to update the configuration set. In step 1506, if received, the UE in step 1508, updates UE TRx configurations according to the newly configured configuration set. In step 1506, if not received, the UE in step 1510 operates the UE TRx according to the configured configuration set.

In some embodiments, the most significant bit (MSB) or least significant bit (LSB) of an SSB ID indicates a TSI ID. For example, MSB state of “0” means TSI 0, and MSB state of “1” means TSI 1; or vice versa. LSB can be used similarly. For example, in the FR2 band where a maximum of 64 SSBs are allowed, the first 32 SSBs could be assigned for zone 1 and the second 32 SSBs for zone 2, if the MSB is used for the SSB zone indication. On the other hand, if the LSB is used for the SSB zone indication, then the odd SSB beams are zone 1 beams and the even SSB beams are zone 2 beams, or vice versa.

As the UE moves round the cell, a BS can decide to change the zone that the UE is associated with. There are switching from zone 1 to zone 2, or from zone 2 to zone 1.

FIG. 16 illustrates a flowchart of a zone/beam switch and indication 1600 according to various embodiments of the present disclosure. An embodiment of the zone/beam switch and indication 1600 shown in FIG. 16 is for illustration only. The zone/beam switch and indication 1600 as may be performed by a UE (e.g., 111-116 as illustrated in FIG. 1) and a BS (e.g., 101-103 as illustrated in FIG. 1). An embodiment of the zone/beam switch and indication 1600 shown in FIG. 16 is for illustration only. One or more of the components illustrated in FIG. 16 can be implemented in specialized circuitry configured to perform the noted functions or one or more of the components can be implemented by one or more processors executing instructions to perform the noted functions.

The overall procedure of zone switching and indication is summarized in FIG. 16.

As illustrated in FIG. 16, in step 1603, a UE reports SSB or CSI-RS RSRP to a BS. In step 1604, the UE and a network's traffic and other information is provided. In step 1606, the BS decides the zone and beam assignment of users. In step 1608, it is determined whether the zone switching operation is occurred. In step 1610, the BS indicates the new zone ID and beam ID to the user if there is a zone switch in step 1608. In step 1612, the UE changes beam and zone related configuration. In step 1608, if the zone switch does not occur, in step 1614, it is determined whether the beam change with the same zone occurs. In step 1614, if the beam change occurred, the BS, in step 1616, indicates the new beam ID to the user; otherwise, the BS maintains the same beam. In step 1618, the UE changes its beam.

In one embodiment, the BS determines whether to switch a zone for a user (see also FIG. 15), based on the RSRP reports of zone 1 and zone 2 reference signals (e.g., SSB or CSI-RS). With SSB based beam management, the BS collects reports from a UE on multiple SSBs, some of which are for zone 1, and others are for zone 2. The BS may decide to switch a zone for a UE if the RSRP value of an SSB for another zone is offset better than the RSRP of the serving SSB. Here, the serving SSB ID is indicated via TCI (transmission configuration indicator), through RRC, MAC-CE or DCI signaling, and is used by the UE for e.g., deriving PL for the UL power control, determining pathloss reference RS, determining the UE Rx beam, etc.

For the zone (or UE TRx setting) switching, in some embodiments, the BS updates TCI value via MAC-CE or RRC signaling. The information conveyed through TCI value includes at least some of a number of MIMO layers, whether a UE is supposed to use Rx beamforming or not, or UE Tx power related behaviors (e.g., UE maximum Tx power value), etc. This set of parameters determine a UE TRx setting, which corresponds to a specific zone the BS has set for its operation.

The UE is RRC configured with multiple config sets, each of which corresponds to a UE TRx setting or a BS TRx zone. TABLE 3 shows an example of these multiple config sets. As shown in TABLE 3, a BS configures different parameter values for different config sets, for a same pool of parameters. In this example, BS configures config set 1 for UE's spatial multiplexing operation and set 2 for UE's beamforming operation.

TABLE 3
Multiple configuration sets

| Parameters in each config set | Config set 1 | Config set 2 |
|---|---|---|
| BS operation zone | Zone 1 | Zone 2 |
| | (spatial | (beamforming) |
| | multiplexing) | |
| Config set ID | 1 | 2 |
| Number of MIMO layers | 8 | 2 |
| DCI format | A first format | A second format |
| UE Rx beamforming | Turned off | Turned on |
| UE maximum Tx power | 23 dBm | 22 dBm |
| value | | |
| SRS configuration | SRS resource set S | None |
| CSI-RS for beam reporting | None | CSI-RS resource |
| (CRI and RSRP) | | set X |
| CSI-RS for CSI reporting | CSI-RS resource | CSI-RS resource |
| (CQI, PMI, RI, etc.) | Y, configured | Z, configured |
| | with e.g., 128 ports | with e.g., 2 ports |

When a UE is indicated to update a config set from set 1 to set 2, the UE changes its config as in the following: the maximum number of layers to 2 from 8, DCI payload and/or format, turn on a UE Rx beamforming, a UE maximum Tx power value to 22 from 23 dBm, stop the SRS transmissions, use CSI-RS resource set X for beam reporting purpose, and use CSI-RS resource Z for CSI reporting purpose.

On the other hand, when a UE is indicated to update a config set from set 2 to set 1, the UE changes its config as in the following: the maximum number of layers from 8 to 2, DCI payload and/or format, turn off UE Rx beamforming and turn on spatial multiplexing receivers, UE maximum Tx power to 23 from 22 dBm, start SRS transmissions, e.g., according to SRS resource set S, turn off beam reporting, and use CSI-RS resource Y for CSI reporting purpose.

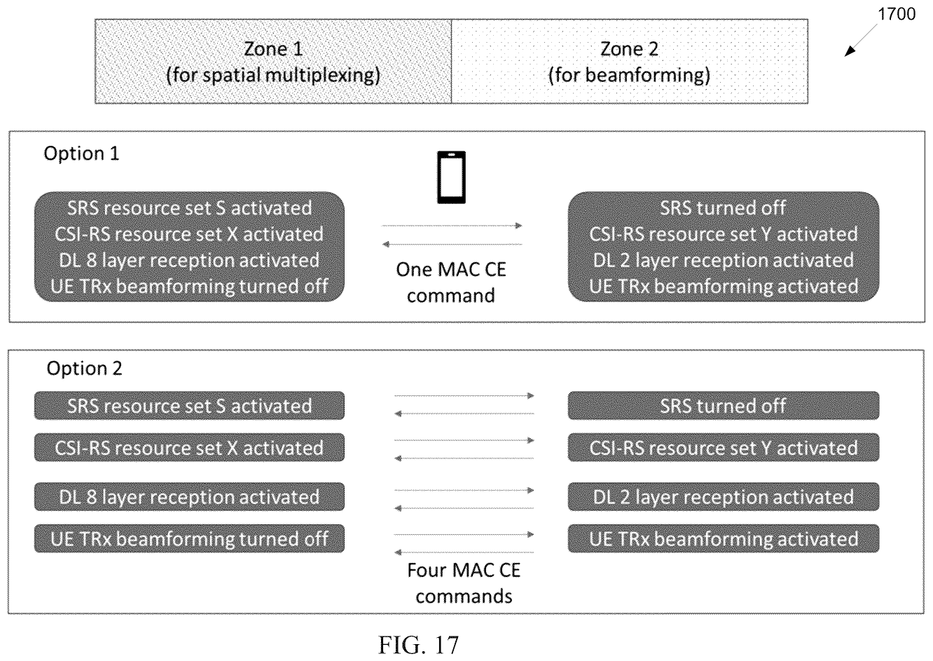

FIG. 17 illustrates an examples of UE's zone switching 1700 according to various embodiments of the present disclosure. An embodiment of the UE's zone switching 1700 shown in FIG. 17 is for illustration only.

In some embodiments, all these changes of the parameters are indicated by a single MAC CE command, to switch from one config set to another; this is illustrated as Option 1 in FIG. 17. In one alternative, the parameters are updated separately by separate MAC CE commands; this is illustrated as Option 2 in FIG. 17.

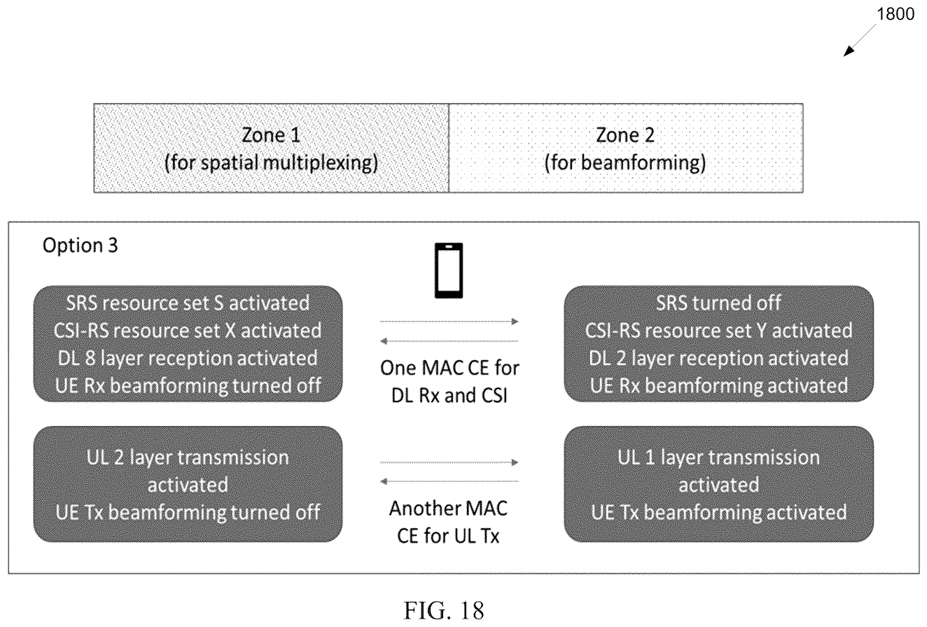

In some embodiments, these changes of the parameters are indicated by a few MAC CE commands. In such a case, these parameters are partitioned into a few groups. Each MAC CE command is associated with each group of parameters. For example, the grouping is done such a way that the PUSCH related parameters (e.g., max number of PUSCH transmission layers, whether to apply UE Tx beamforming or not, etc.) are grouped into one, and PDSCH (e.g., max number of PDSCH transmission layers, whether to apply UE Rx beamforming or not, etc.), CSI-RS, CSI reporting and SRS related parameters are grouped into one. This is illustrated as option 3 in FIG. 18.

FIG. 18 illustrates another examples of UE's zone switching 1800 according to various embodiments of the present disclosure. An embodiment of the UE's zone switching 1800 shown in FIG. 18 is for illustration only.

For these transitions, in some embodiments, the SRS and CSI-RS resource sets configured for config set 2 is restricted to be aperiodic type only to ensure efficient network's resource utilizations. If periodic type is configured, for example, those resource sets may need to be reserved and not available for the networks' use even when the UE is in zone 1.

In some embodiments, a TCI corresponds to a config set. In other words, a TCI informs a UE extra information of maximum number of MIMO layers, a UE Rx beamforming, etc., in addition to CSI-RS resource set, CSI reporting config, etc., according to the legacy specifications.

One example construction of a new TCI configuration is as in the following, where two underlined parameters are newly added to support the UE TRx setting switching operation. Here, max-number-of-PDSCH-transmission-layers and max-number-of-PUSCH-transmission-layers indicate the maximum number of PDSCH/PUSCH transmission layers the UE may expect, and the DMRS port indicator in the DCI may be interpreted differently according to this field. ue-Rx-Beamforming is used to indicate UE whether to enable or disable the UE Rx beamforming. In some embodiments, more information elements are appended to TCI-State, e.g., an information element to indicate the bitwidth and contents of a DCI field (e.g., DMRS port indicator), etc. TABLE 4 shows the TCI-State elements.

TABLE 4
TCI-State elements

```
TCI-State ::= SEQUENCE {
  tci-StateId TCI-StateId,
  qcl-Type1 QCL-Info,
  qcl-Type2 QCL-Info OPTIONAL, -- Need R
  ...,
  [[
  additionalPCI-r17 AdditionalPCIIndex-r17 OPTIONAL, -- Need R
  pathlossReferenceRS-Id-r17 PUSCH-PathlossReferenceRS-Id OPTIONAL, -- Cond
  JointTCI
  ul-powerControl-r17 Uplink-powerControlId-r17 OPTIONAL -- Cond JointTCI
  ]]
  max-number-of-PDSCH-transmission-layers ENUMERATED {1, 2, 4, 8, 16},
  max-number-of-PUSCH-transmission-layers ENUMERATED {1, 2, 4, 8},
  ue-Rx-Beamforming ENUMERATED {enabled} OPTIONAL
}
```

In some embodiments, a new config index, namely transceiver mode indicator (TSI), is introduced, for indicating a config set. This way, more flexible and overhead-efficient parameter configuration are achieved. This TSI configuration could be independent of TCI or could include a TCI state. As such, MI-State can be introduced, and TSI-State optionally includes a TCI-StateId, and other configuration parameters to determine UE's TRx setting, which include at least some of maximum number of MIMO layers, a UE Rx beamforming, a CSI reporting configuration, an SRS configuration, etc. One example construction of the new TSI information element is as in the TABLE 5.

TABLE 5
TSI-state

```
TSI-State = {
  tmi-StateId TSI-StateId,
  tci-StateId TCI-StateId OPTIONAL,
  max-number-of-PDSCH-transmission-layers ENUMERATED {1, 2, 4,
  8, 16},
  max-number-of-PUSCH-transmission-layers ENUMERATED {1, 2, 4,
  8},
  ue-Rx-Beamforming ENUMERATED {enabled} OPTIONAL,
  csi-ReportConfigId CSI-ReportConfigId, OPTIONAL
  srs-ResourceSetId SRS-ResourceSetId, OPTIONAL
}
```

Here, TSI-StateID is a unique identifier for the TSI, which may be used as an index to identify this TSI-State in RRC, MAC-CE and DCI signaling. tci-StateId is indicated inside TSI-State, to let a UE knows of the QCL assumption and other TCI indicated beam management parameter values configured through the corresponding TCI state. CSI-ReportConfig and SRS-ResourceSetId are analogous to those used in the 3GPP NR specifications 38.331, and they are used for indicating a particular CSI reporting configuration and a particular SRS resource set, respectively. In some embodiments, SRS-ResourceId is used instead of SRS-ResourceSetId, to allow switching across different SRS resources using the TSI-StateID, instead of SRS resource sets.

In some embodiments, a UE is configured a list of PDSCH/PUSCH config for each DL/UL BWP, and the UE is further indicated with a particular PDSCH/PUSCH config to use. For an initial RRC setup, the UE is configured to use a default one (e.g., the first one with lowest ID). Later, the BS can inform the UE to switch to another PDSCH/PUSCH config via RRC, MAC-CE or DCI signaling. The same approach can be applied to PDCCH and PUSCH as well.

One example construction of BWP configuration according to these embodiments is as in the following TABLE 6.

TABLE 6
BWP-DownlinkDedicated elements

BWP-DownlinkDedicated ::= SEQUENCE {
pdcch-ConfigToAddModList SEQUENCE
(SIZE(1...maxNrofPDCCH-Configs) OF PDCCH-Config
pdsch-ConfigToAddModList SEQUENCE
(SIZE(1...maxNrofPDSCH-Configs) OF PDSCH-Config
..
}
BWP-UplinkDedicated ::= SEQUENCE {
pucch-ConfigToAddModList SEQUENCE
(SIZE(1...maxNrofPUCCH-Configs) OF PUCCH-Config
pusch-ConfigToAddModList SEQUENCE
(SIZE(1...maxNrofPUSCH-Configs) OF PUSCH-Config
...
}

An identifier is added to individual configs of PDCCH, PDSCH, PUCCH, and PUSCH, so that in further RRC, MAC CE and DCI, the identifier can be used for indicating a particular config.

In these embodiments, TCI-Info can be included in the ServingCellConfig 1E, to facilitate independent TCI switching of PDCCH/PUSCH/PUCCH/PDSCH switching.

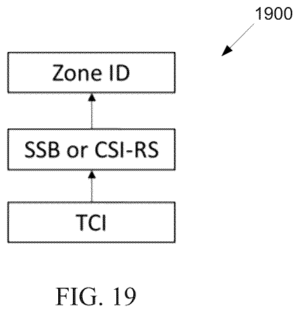

FIG. 19 illustrates an examples of zone ID that is implicated indicated through TCI 1900 according to various embodiments of the present disclosure. An embodiment of the zone ID that is implicated indicated through TCI 1900 shown in FIG. 19 is for illustration only.

In some embodiments, an SSB and CSI-RS resource configuration include TSI-Stateld to associate individual RS with a specific TSI (or a zone). There is a resource ID for SSB and CSI-RS. Individual TCI is associated with resource ID. By going through the chain from TCI to SSB/CSI-RS ID to zone ID as shown in FIG. 19, a UE is implicitly informed of the change of the zone (or TSI ID). TCI can be indicated though RRC/MAC-CE/DCI, where RRC/MAC-CE provide a set of TCIs and MAC-CE/DCI indicates the selected single TCI. TCI can be separately indicated for DL and UL, or unified for DL and UL. In the former case, the user could be assigned to different zones in DL and UL. In the latter case, the user is in the same zone for both DL and UL.

In another embodiment, the explicit zone indication could be adopted. For example, a BS could send a 1-bit zone ID indication through DCI/MAC-CE to UE.

The present disclosure provides a BM procedure P-1, P-2 and P-3 defined in 3GPP TR 38.802: (1) P-1: is used to enable UE measurement on different TRP Tx beams to support selection of TRP Tx beams/UE Rx beam(s); (2) P-2: is used to enable UE measurement on different TRP Tx beams to possibly change inter/intra-TRP Tx beam(s): from a possibly smaller set of beams for beam refinement than in P-1. Note that P-2 can be a special case of P-1; and (3) P-3: is used to enable UE measurement on the same TRP Tx beam to change UE Rx beam in the case UE uses beamforming.

In the multi-zone case, the operation procedure is provided as follows.

In one embodiment, the BS determines the zone ID for each UE in P-1, by using an SSB the UE selected for the initial access as TCI for the subsequent transmissions. In connected mode, the UE measures the SSBs and reports the RSRPs. Then the BS assigns the UE to zone 1 or 2 based on the RSRP report and the network load.

In some embodiments, users in zone 1 and zone are configured with different beam management procedures.

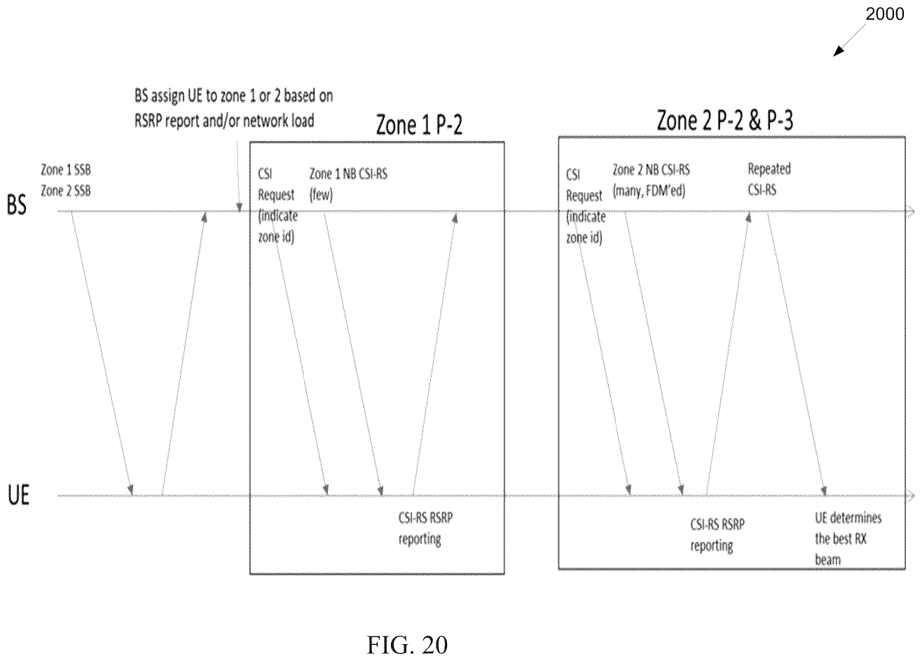

FIG. 20 illustrates an examples of zone-specific beam management 2000 according to various embodiments of the present disclosure. An embodiment of the zone-specific beam management 2000 shown in FIG. 20 is for illustration only.

In some embodiments, the BS performs the P-3 phase for zone 2 users but skips it for the zone 1 users. The overall operation is given in FIG. 20. For zone 1 users, the BS may do P-2 phase for refine the BS Tx beam for each zone 1 UEs. This step called as “Zone 1 P-2.” There is no P-3 step for zone 1 users since they are not tuned for spatial multiplexing reception. On the other hand, there is both P-2 and P-3 phases for Zone 2 users since they are typically at the cell edge and the UE beam refinement is needed.

In some embodiments, a BS skips the P-2 phase for zone 1 UEs (i.e., no CSI-RS transmissions for these zone 1 UEs for beam refinement) since those UEs are close to the BS and no higher gain beamforming is needed. On the other hand, the BS performs the P-2 phase for zone 2 UEs (i.e., CSI-RS transmissions for these zone 2 UEs for beam refinement and receive LI RSRP feedback from those UEs) e.g., when hierarchical beambooks are used for zone 2 users.

In some embodiments, the P-2 phase is skipped for the zone 2 users. Since the zone 2 SSB beams are typically narrow beams, the best narrow beam of BS could be already determined in the P-1 phase, and thus there is no need for BS Tx beam refinement.

The CSI-RS configuration could be different between zones to accommodate the spatial multiplexing and beamforming modes.

CSI-RS for CSI measurement (for CQI, PMI, RI, etc.): (1) for SSB switching within zone 1; or if BS wants to switch a UE from zone 2 SSB to zone 1 SSB, a UE is configured with a new CSI-RS resource and corresponding report Config with e.g., 32 port CSI-RS; and (2) for zone 1 to zone 2 switching, and for one zone 2 SSB to another zone 2 SSB, a UE is configured with a new CSI-RS resource and corresponding report Config with e.g., 2 port CSI-RS.

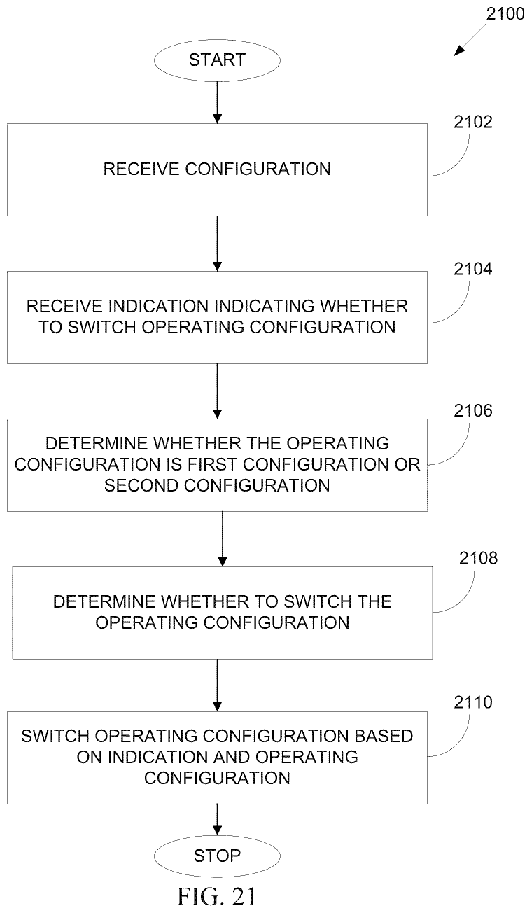

FIG. 21 illustrates a flowchart of UE method 2100 for a transmission setting indication for switching operation zones according to various embodiments of the present disclosure. The UE method 2100 as may be performed by a UE (e.g., 111-116 as illustrated in FIG. 1). An embodiment of the UE method 2100 shown in FIG. 21 is for illustration only. One or more of the components illustrated in FIG. 21 can be implemented in specialized circuitry configured to perform the noted functions or one or more of the components can be implemented by one or more processors executing instructions to perform the noted functions.

As illustrated in FIG. 21, the method 2100 begins at step 2102. In step 2102, a UE receives, from a BS, configuration information including (i) a first configuration corresponding to a first transmission/reception setting and (ii) a second configuration corresponding to a second transmission/reception setting, wherein the configuration information is included in an RRC message.

In step 2104, the UE receives, from the BS, an indication indicating whether to switch an operating configuration, wherein the indication is included in a MAC CE or DCI.

In step 2106, the UE determines whether the operating configuration is the first configuration or the second configuration.

In step 2108, the UE determines, based on the indication, whether to switch the operating configuration between the first configuration and the second configuration.

In step 2110, the UE switches, based on a determination that the operating configuration is indicated to be switched and the operating configuration is the first configuration, the operating configuration from the first configuration to the second configuration.

In such embodiments, the first transmission/reception setting and the second transmission/reception setting are associated with a number of transmission layers for a spatial multiplexing operation or a beamforming operation.

In one embodiment, the UE switches, based on a determination that the operating configuration is indicated to be switched and the operating configuration is the second configuration, the operating configuration from the second configuration to the first configuration.

In such embodiments, the first transmission/reception setting corresponds to a first UE group and the second transmission/reception setting corresponds to a second UE group.

In such embodiments, the first configuration corresponds to a first TCI state and the second configuration corresponds to a second TCI state, the indication further corresponds to a TCI index indicating the first TCI state or the second TCI state, and the first TCI state corresponds to a first set of SSBs and the second TCI state corresponds to a second set of SSBs.

In such embodiments, the TCI state includes at least one of: a maximum number of PDSCH transmission layers for a Tx beamforming operation; a maximum number of PUSCH transmission layers for a Rx beamforming operation; and UE-Rx-beamforming information used to indicate, to the UE, whether to enable or disable the Rx beamforming operation.

In such embodiments, the indication further corresponds to a transmission/reception setting index indicating the first transmission/reception setting or the second transmission/reception setting, and the first transmission/reception setting and the second transmission/reception setting include, respectively, at least one of: a TCI state, a maximum number of PDSCH transmission layers for a Tx beamforming operation, a maximum number of PUSCH transmission layers for a Rx beamforming operation, UE-Rx-beamforming information used to indicate whether to enable or disable the Rx beamforming operation, a CSI reporting, and an SRS resource set.

In one embodiment, the UE identifies the configuration corresponding to a group of parameters comprising at least one of a PDSCH-config, a PDCCH-config, and a PUSCH-config. 1n such embodiments, the first configuration corresponds to a first group of parameters, the second configuration corresponds to a second group of parameters, and the group of parameters corresponds to a bandwidth part configuration.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to:
receive, from a base station (BS), configuration information including (i) a first configuration corresponding to a first transmission/reception setting and (ii) a second configuration corresponding to a second transmission/reception setting, wherein the configuration information is included in a radio resource control (RRC) message, and
receive, from the BS, an indication indicating whether to switch an operating configuration, wherein the indication is included in a medium access control control element (MAC CE) or downlink control information (DCI); and
a processor operably coupled to the transceiver, the processor configured to:
determine whether the operating configuration is the first configuration or the second configuration,
determine, based on the indication, whether to switch the operating configuration between the first configuration and the second configuration, and
switch, based on a determination that the operating configuration is indicated to be switched and the operating configuration is the first configuration, the operating configuration from the first configuration to the second configuration,
wherein the first transmission/reception setting and the second transmission/reception setting are associated with a number of transmission layers for a spatial multiplexing operation or a beamforming operation.

2. The UE of claim 1, wherein the processor is further configured to:
switch, based on a determination that the operating configuration is indicated to be switched and the operating configuration is the second configuration, the operating configuration from the second configuration to the first configuration.

3. The UE of claim 1, wherein:
the first transmission/reception setting corresponds to a first UE group; and
the second transmission/reception setting corresponds to a second UE group.

4. The UE of claim 1, wherein:
the first configuration corresponds to a first transmission configuration information (TCI) state and the second configuration corresponds to a second TCI state;
the indication further corresponds to a TCI index indicating the first TCI state or the second TCI state; and
the first TCI state corresponds to a first set of synchronization signal blocks (SSBs) and the second TCI state corresponds to a second set of SSBs.

5. The UE of claim 4, wherein the TCI state includes at least one of:
a maximum number of physical downlink shared channel (PDSCH) transmission layers for a transmit (Tx) beamforming operation;
a maximum number of physical uplink shared channel (PUSCH) transmission layers for a receive (Rx) beamforming operation; and
UE-Rx-beamforming information used to indicate, to the UE, whether to enable or disable the Rx beamforming operation.

6. The UE of claim 1, wherein:
the indication further corresponds to a transmission/reception setting index indicating the first transmission/reception setting or the second transmission/reception setting; and
the first transmission/reception setting and the second transmission/reception setting include, respectively, at least one of:
a transmission configuration information (TCI) state,
a maximum number of physical downlink shared channel (PDSCH) transmission layers for a transmit (Tx) beamforming operation,
a maximum number of physical uplink shared channel (PUSCH) transmission layers for a receive (Rx) beamforming operation,
UE-Rx-beamforming information used to indicate whether to enable or disable the Rx beamforming operation,
a channel state information (CSI) reporting, and
a sounding reference signal (SRS) resource set.

7. The UE of claim 1, wherein:
the processor is further configured to identify the configuration corresponding to a group of parameters comprising at least one of a physical downlink shared channel (PDSCH) configuration (PDSCH-config), a physical downlink control channel (PDCCH-config), and a physical uplink shared channel (PUSCH-config);
the first configuration corresponds to a first group of parameters;
the second configuration corresponds to a second group of parameters; and
the group of parameters corresponds to a bandwidth part configuration.

8. A method of a user equipment (UE), the method comprising:
receiving, from a base station (BS), configuration information including (i) a first configuration corresponding to a first transmission/reception setting and (ii) a second configuration corresponding to a second transmission/reception setting, wherein the configuration information is included in a radio resource control (RRC) message;
receiving, from the BS, an indication indicating whether to switch an operating configuration, wherein the indication is included in a medium access control element (MAC CE) or downlink control information (DCI);
determining whether the operating configuration is the first configuration or the second configuration;
determining, based on the indication, whether to switch the operating configuration between the first configuration and the second configuration; and
switching, based on a determination that the operating configuration is indicated to be switched and the operating configuration is the first configuration, the operating configuration from the first configuration to the second configuration,
wherein the first transmission/reception setting and the second transmission/reception setting are associated with a number of transmission layers for a spatial multiplexing operation or a beamforming operation.

9. The method of claim 8, further comprising switching, based on a determination that the operating configuration is indicated to be switched and the operating configuration is the second configuration, the operating configuration from the second configuration to the first configuration.

10. The method of claim 8, wherein:
the first transmission/reception setting corresponds to a first UE group; and
the second transmission/reception setting corresponds to a second UE group.

11. The method of claim 8, wherein:
the first configuration corresponds to a first transmission configuration information (TCI) state and the second configuration corresponds to a second TCI state;
the indication further corresponds to a TCI index indicating the first TCI state or the second TCI state; and
the first TCI state corresponds to a first set of synchronization signal blocks (SSBs) and the second TCI state corresponds to a second set of SSBs.

12. The method of claim 11, wherein the TCI state includes at least one of:
a maximum number of physical downlink shared channel (PDSCH) transmission layers for a transmit (Tx) beamforming operation;
a maximum number of physical uplink shared channel (PUSCH) transmission layers for a receive (Rx) beamforming operation; and
UE-Rx-beamforming information used to indicate, to the UE, whether to enable or disable the Rx beamforming operation.

13. The method of claim 8, wherein:
the indication further corresponds to a transmission/reception setting index indicating the first transmission/reception setting or the second transmission/reception setting; and
the first transmission/reception setting and the second transmission/reception setting include, respectively, at least one of:
a transmission configuration information (TCI) state,
a maximum number of physical downlink shared channel (PDSCH) transmission layers for a transmit (Tx) beamforming operation,
a maximum number of physical uplink shared channel (PUSCH) transmission layers for a receive (Rx) beamforming operation,
UE-Rx-beamforming information used to indicate whether to enable or disable the Rx beamforming operation,
a channel state information (CSI) reporting, and
a sounding reference signal (SRS) resource set.

14. The method of claim 8, further comprising identifying the configuration corresponding to a group of parameters comprising at least one of a physical downlink shared channel (PDSCH) configuration (PDSCH-config), a physical downlink control channel (PDCCH-config), and a physical uplink shared channel (PUSCH-config),
wherein:
the first configuration corresponds to a first group of parameters;
the second configuration corresponds to a second group of parameters; and
the group of parameters corresponds to a bandwidth part configuration.

15. A base station (BS) in a wireless communication system, the BS comprising:
a processor configured to:
generate configuration information including (i) a first configuration corresponding to a first transmission/reception setting and (ii) a second configuration corresponding to a second transmission/reception setting, and
generate an indication indicating whether to switch an operating configuration; and
a transceiver operably coupled to the processor, the transceiver configured to:
transmit, to a user equipment (UE) via a radio resource control (RRC) message, the configuration information, and
transmit, to the UE via a medium access control control element (MAC CE) or downlink control information (DCI), the indication,
wherein:
the operating configuration is the first configuration or the second configuration,
the switch of the operating configuration between the first configuration and the second configuration is based on the indication, and
the first transmission/reception setting and the second transmission/reception setting are associated with a number of transmission layers for a spatial multiplexing operation or a beamforming operation.

16. The BS of claim 15, wherein:
the first transmission/reception setting corresponds to a first UE group; and
the second transmission/reception setting corresponds to a second UE group.

17. The BS of claim 15, wherein:
the first configuration corresponds to a first transmission configuration information (TCI) state and the second configuration corresponds to a second TCI state;
the indication further corresponds to a TCI index indicating the first TCI state or the second TCI state; and
the first TCI state corresponds to a first set of synchronization signal blocks (SSBs) and the second TCI state corresponds to a second set of SSBs.

18. The BS of claim 17, wherein the TCI state includes at least one of:
a maximum number of physical downlink shared channel (PDSCH) transmission layers for a transmit (Tx) beamforming operation;
a maximum number of physical uplink shared channel (PUSCH) transmission layers for a receive (Rx) beamforming operation; and
UE-Rx-beamforming information used to indicate, to the UE, whether to enable or disable the Rx beamforming operation.

19. The BS of claim 15, wherein:
the indication further corresponds to a transmission/reception setting index indicating the first transmission/reception setting or the second transmission/reception setting; and
the first transmission/reception setting and the second transmission/reception setting include, respectively, at least one of:
a transmission configuration information (TCI) state,
a maximum number of physical downlink shared channel (PDSCH) transmission layers for a transmit (Tx) beamforming operation,
a maximum number of physical uplink shared channel (PUSCH) transmission layers for a receive (Rx) beamforming operation,
UE-Rx-beamforming information used to indicate whether to enable or disable the Rx beamforming operation,
a channel state information (CSI) reporting, and
a sounding reference signal (SRS) resource set.

20. The BS of claim 15, wherein:
the configuration corresponds to a group of parameters comprising at least one of a physical downlink shared channel (PDSCH) configuration (PDSCH-config), a physical downlink control channel (PDCCH-config), and a physical uplink shared channel (PUSCH-config);
the first configuration corresponds to a first group of parameters;
the second configuration corresponds to a second group of parameters; and
the group of parameters corresponds to a bandwidth part configuration.
